(19) United States
(12) Patent Application Publication
(10) Pub. No.: US 2003/0115148 A1
(43) Pub. Date: Jun. 19, 2003

(54) Method and apparatus for processing a secure transaction

(76) Inventor: Harinder Singh Takhar, Bemidji, MN (US)

Correspondence Address: MERCHANT & GOULD PC, P.O. BOX 2903, MINNEAPOLIS, MN, 55402-0903, US

(21) Appl. No.: 10/017,046

(22) Filed: Dec. 13, 2001

(51) Int. Cl. G06F 17/60

(52) U.S. Cl. 705/64

(57) ABSTRACT

A computer process, a computing system or an article of manufacture for processing a secure transaction. A process of accepting a secure transaction from a lockbox that stores private information accessible via a security protocol includes the steps of accepting a transaction initiated by a lockbox, determining whether the transaction was initiated by a lockbox, and identifying the transaction as a lockbox transaction. The method can include the step of determining what security protocol was used to initiate the transaction.

### TECHNICAL FIELD

The present invention relates to a method and system for processing a secure transaction. In another aspect, the invention relates to a method and system for authorizing transactions via the internet.

### BACKGROUND OF THE INVENTION

There is a chance that one or more of the parties to the transaction are not authorized to enter into the transaction. For face-to-face transactions between people that know each other, there is a level of trust that enables transactions to proceed. In other situations, there is a risk that the transaction is not authorized by the proper party to the transaction. On one hand, there is need to develop a system that promotes the trust associated with face-to-face transactions between people that know each other in order to enable organizations to verify the identity of any individual (an employee, customer, client, supplier, student, patient, doctor, claimant, prisoner, or visitor) who needs to authorize access, transactions, payment or delivery face-to-face or online, exchange information, enter a building or restricted area, log on, or access networks or databases. On the other hand, individuals and entities are hesitant to share with others private information and seek to share only the information absolutely necessary to go forward with a transaction.

### SUMMARY OF THE INVENTION

Generally, the present invention relates to a method of initiating and processing a secure transaction. One embodiment is a method of accepting a secure transaction from a lockbox that stores private information accessible via a security protocol. The method has the steps of accepting a transaction initiated by a lockbox, determining whether the transaction was initiated by a lockbox, and identifying the transaction as a lockbox transaction. In another embodiment, the method includes the step of determining what security protocol was used to initiate the transaction. The security protocol can include a PIN, biometric, and/or password.

In other embodiments, a system for processing transactions is provided. The system includes a lockbox module storing private information accessible via a security protocol, a transaction module coupled to the lockbox module for initiating a transaction, a transaction site module for receiving a transaction, and an identification module for identifying a transaction as originating from a lockbox. The transaction site module does not receive private information to process a transaction. The system can also include an audit module for storing a change in security protocol and a transaction log.

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

The above summary of the present invention is not intended to describe each disclosed embodiment or every implementation of the present invention. The figures and the detailed description which follow more particularly exemplify these embodiments.

### BRIEF DESCRIPTION OF THE DRAWINGS

FIG. 1 illustrates one possible organization of a distributed interactive computing system for implementing an embodiment of the present invention;

FIG. 2 illustrates computers 102, 103, 104 or 105 according to one embodiment of the present invention;

FIG. 3 illustrates one embodiment of a secure transaction system 300 according to the present invention;

FIG. 4 illustrates a process flow for processing a secure transaction according to one embodiment of the present invention;

FIG. 5 illustrates a process flow for processing a secure transaction according to another embodiment of the present invention;

FIG. 6 illustrates a process flow for a merchant application according to one embodiment of the present invention;

FIG. 7 illustrates a process flow for an off-site identification transaction according to one embodiment of the present invention;

FIG. 8 illustrates a process flow for an off-site identification transaction according another embodiment of the present invention;

FIG. 9 illustrates a process flow for an off-site identification transaction according another embodiment of the present invention;

FIG. 10 illustrates a process flow for an identification transaction according to one embodiment of the present invention;

FIG. 11 illustrates a process flow for an identification transaction according to another embodiment of the present invention;

FIG. 12 illustrates a process flow for an identification transaction according to another embodiment of the present invention;

FIG. 13 illustrates a process flow for a merchant transaction according to another embodiment of the present invention;

FIG. 14 illustrates a process flow for an electronic document transaction according to one embodiment of the present invention;

FIG. 15 illustrates a process flow for opening lockbox 302 according to one embodiment of the present invention; and

FIG. 16 illustrates a process flow for processing a transaction within lockbox 302 according to one embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE INVENTION

The present invention is believed to be applicable to methods and devices for processing a secure transaction. While the present invention is not so limited, an appreciation of various aspects of the invention will be gained through a discussion of the examples provided below. A system and method is provided for processing a secure transaction. The system provides a lockbox to store private information and a system for transactions to be processed from within the lockbox. The transactions can be between third parties, service providers, and the lockbox owner or authorized user without exposing the private information to misappropriation and without exposing the third party to the risks of executing a fraudulent transaction.

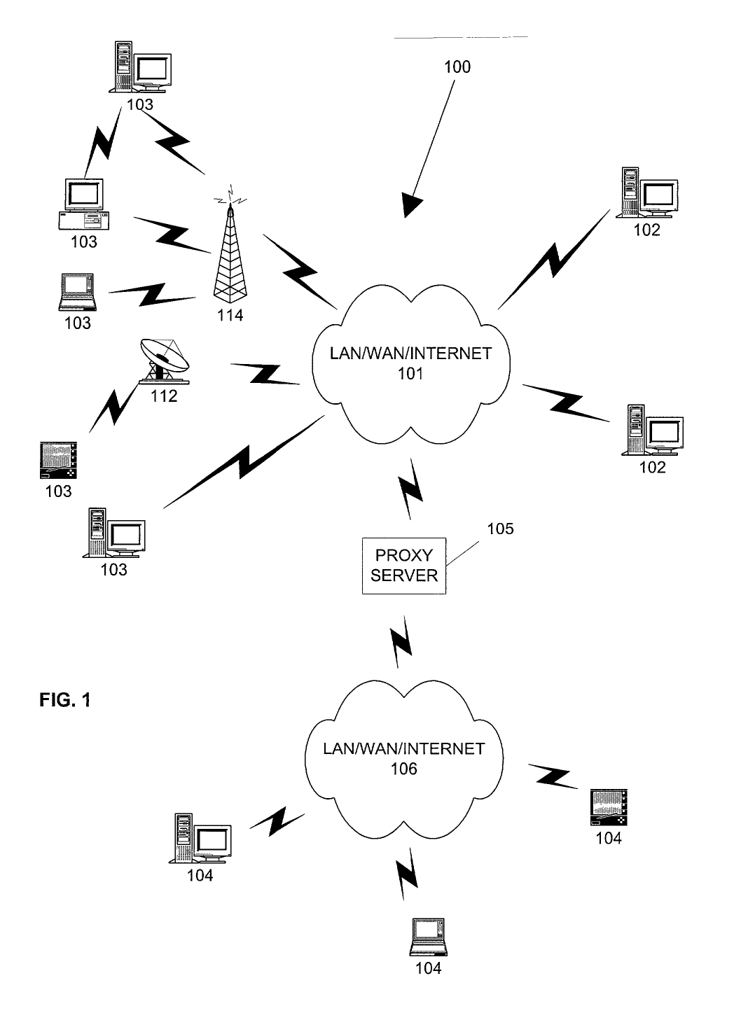

FIG. 1 illustrates one possible organization of a distributed interactive computing system for implementing an embodiment of the present invention. The distributed computing system includes a plurality of computing systems connected together using a communications network. These computing systems can include user workstations, laptop computers, personal digital assistants (PDAs), and cell phones 103 directly connected to a wide area network (WAN) 101. Also connected to the WAN 101 is a plurality of server computers 102. In one possible embodiment of the present invention, the WAN 101 may be the Internet in which user computers 103 connected using a typical dial-up, DSL, or cable connection through an internet service provider (ISP). Computers. In other embodiments the computers 103 can connect to the WAN 101 via a radio tower 114 or satellite 112.

Users of the network may also connect to the communications system using client computers 104 that are connected to a local area network (LAN) 106 in which the LAN 106 is connected to the internet 101 through a proxy server. In this arrangement, the client computers access resources located on the internet 101 by sending the request to the proxy server 105. The proxy server 105 in turn forwards the request to a destination on the internet. The response to this request is received by the proxy server 105 which forwards the request to the requesting client computer 104.

The server computers 102 receive these service requests from the user client computers 103, 104 and generate the appropriate responses. In the preferred embodiment, this communication is using the standard http communications protocol. In other embodiments other known communication methods can be used. The communications are typically secure, e.g., using SSL protocol. The responses generated and returned to the user client computers 103, 104 is typically in the form of a web page specified in HTML that may be displayed to the user utilizing a web browser such as MICROSOFT INTERNET EXPLORER or NETSCAPE NAVIGATOR.

The server computers 102 may store information such as information in a database or other electronic data. This data may also be stored in a distributed manner across one or more server computers 102. A web site can be programmed to access any of this data. Client computer 103 programs, such as browsers, allow a remote user to access the information stored on the web site and to navigate around the web. Generally, browsers employ a graphical user interface displayed on a monitor which allows the computer 103 to utilize a mouse or other input device perform server 102 and data accession and navigation functions via the graphical interface. The server computer 102 can also be accessed via interactive voice response systems (IVR) or other known methods to provide an interface between humans and computers.

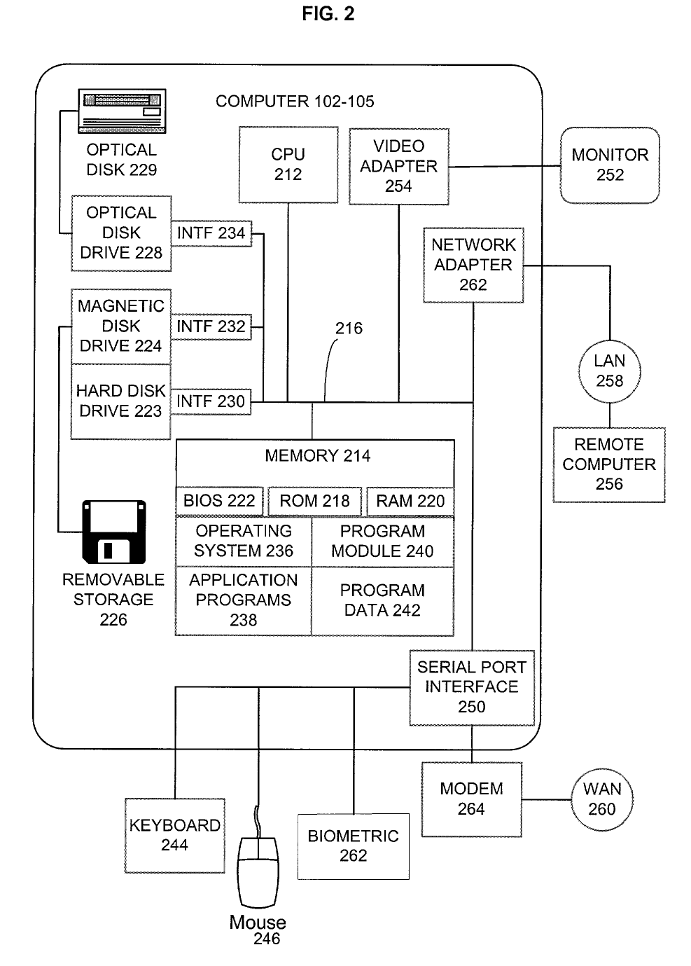

FIG. 2 illustrates computers 102, 103, 104 or 105 according to one embodiment of the present invention. An exemplary computing system for an embodiment of the invention includes a general purpose computing device in the form of a conventional computer system 102, 103, 104, or 105 including a processor unit 212, a system memory 214, and a system bus 216 that couples various system components including the system memory 214 to the processor unit 212. The system bus 216 may be any of several types of bus structures including a memory bus or memory controller, a peripheral bus and a local bus using any of a variety of bus architectures. The system memory includes read only memory (ROM) 218 and random access memory (RAM) 220. A basic input/output system 222 (BIOS), which contains basic routines that help transfer information between elements within the computer system 102, 103, 104, or 105, is stored in ROM 218.

The computer system 102, 103, 104, or 105 further includes a hard disk drive 223 for reading from and writing to a hard disk, a magnetic disk drive 224 for reading from or writing to a removable magnetic disk 226, and an optical disk drive 228 for reading from or writing to a removable optical disk 229 such as a CD ROM, DVD, or other optical media. The hard disk drive 223, magnetic disk drive 224, and optical disk drive 228 are connected to the system bus 216 by a hard disk drive interface 230, a magnetic disk drive interface 232, and an optical drive interface 234, respectively. The drives and their associated computer-readable media provide nonvolatile storage of computer readable instructions, data structures, programs, and other data for the computer system 102, 103, 104, or 105.

Although the exemplary environment described herein employs a hard disk 223, a removable magnetic disk 226, and a removable optical disk 229, other types of computer-readable media capable of storing data can be used in the exemplary system. Examples of these other types of computer-readable mediums that can be used in the exemplary operating environment include magnetic cassettes, flash memory cards, digital video disks, Bernoulli cartridges, random access memories (RAMs), and read only memories (ROMs).

A number of program modules may be stored on the hard disk 223, magnetic disk 226, optical disk 229, ROM 218 or RAM 220, including an operating system 236, one or more application programs 238, other program modules 240, and program data 242. A user may enter commands and information into the computer system 102, 103, 104, or 105, through input devices such as a keyboard 244 and mouse 246 or other pointing device. Examples of other input devices may include a microphone, joystick, game pad, satellite dish, and scanner. Input devices can include a biometric reader 262 which can read a fingerprint, retina, iris or other biometric signal. These and other input devices are often connected to the processing unit 212 through a serial port interface 250 that is coupled to the system bus 216. Nevertheless, these input devices also may be connected by other interfaces, such as a parallel port, game port, or a universal serial bus (USB). A monitor 252 or other type of display device is also connected to the system bus 216 via an interface, such as a video adapter 254. In addition to the monitor 252, computer systems typically include other peripheral output devices (not shown), such as speakers and printers.

The computer system 102, 103, 104, or 105, may operate in a networked environment using logical connections to one or more remote computers, such as a remote computer 256. The remote computer 256 may be a computer system, a server, a router, a network PC, a peer device or other common network node, and typically includes many or all of the elements described above relative to the computer system 102, 103, 104, or 105. The network connections include a local area network (LAN) 258 and a wide area network (WAN) 260. Such networking environments are commonplace in offices, enterprise-wide computer networks, intranets, and the Internet.

When used in a LAN networking environment, the computer system 102, 103, 104, or 105 is connected to the local network 258 through a network interface or adapter 262. When used in a WAN networking environment, the computer system 102, 103, 104, or 105 typically includes a modem 264 or other means for establishing communications over the wide area network 260, such as the Internet. The modem 264, which may be internal or external, is connected to the system bus 216 via the serial port interface 250. In a networked environment, program modules depicted relative to the computer system 102, 103, 104, or 105, or portions thereof, may be stored in the remote memory storage device. It will be appreciated that the network connections shown are exemplary, and other means of establishing a communications link between the computers may be used.

A computing device, such as computer system 102, 103, 104, or 105 typically includes at least some form of computer-readable media. Computer readable media can be any available media that can be accessed by the computer system 102, 103, 104, or 105. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computer system 102, 103, 104, or 105.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

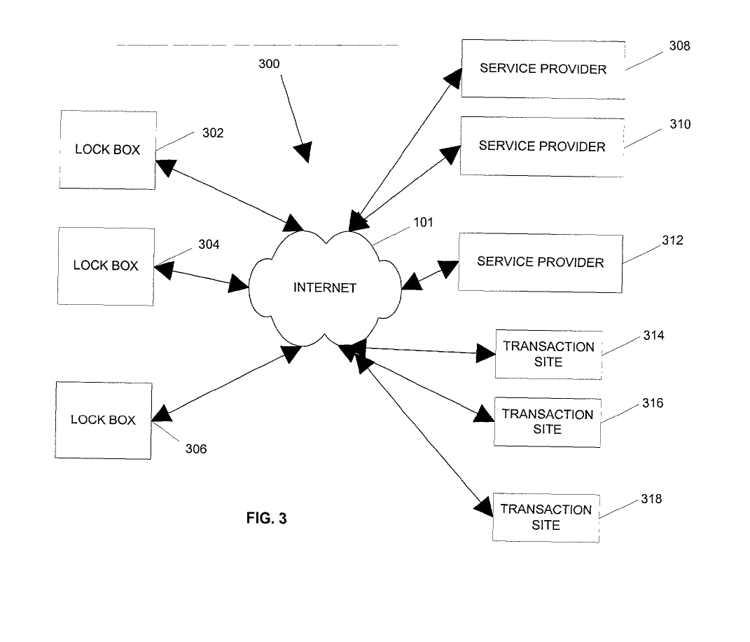

FIG. 3 illustrates one embodiment of a secure transaction system 300 according to the present invention. Secure transaction system 300 includes lockboxes 302, 304, and 306, service providers 308, 310, and 312, and transaction sites 314, 316, and 318 connected via an internet 101. The lockboxes 302, 304, and 306, service providers 308, 310, and 312, and transaction sites 314, 316, and 318 can be executed on computers 102-105. In other embodiments, the lockboxes, service providers, and/or transaction sites can be executed by the same computer or computer system 102-105.

Lockbox 302 provides a secure electronic storage location for private information, a module for initiating transactions requiring the private information, and a module for indicating that a transaction was initiated by the lockbox. The transactions are initiated from within the lockbox without providing the private and confidential information unless the authorized user chooses to provide the information or the transaction requires the private information and the user consents to providing the information.

Private information is any information that an individual or entity seeks to keep private from others. Private information can include financial information (e.g., information related to financial accounts, including bank accounts, credit cards banks, lines of credit, securities, mortgages, and brokerage funds) and identification information (e.g., driver's license, social security number, passport, photograph, biometric information, home address, phone numbers, email addresses, video addresses, and web pages). Private information can also include trade secret or other confidential information, including pricing information, competitive data, and pricing lists. Although private information includes financial information of a user, it does not include financial information related to transaction initiated by a user, such as a record of a payment from a third party to a merchant.

Access to the private information is provided by one or more secure mechanisms specified by the user. No access to the lockbox is permitted unless authorized by the user. A secure access mechanism can be, for example, a PIN, password, fingerprint, retinal scan, iris scan, other biometric, smart card, magnetic strip card, tone, voice recognition, and other known methods of providing secure access to electronic information. These secure access mechanisms can be used alone or in combination to access the lock box. In one embodiment, one or more secure access mechanisms can be designated the primary access mechanism and one or more other secure access mechanisms can be a backup. For example, primary access can be via a fingerprint and backup access can be a PIN and password.

The lockbox can be data and an interface to provide secure access to the data. The communication with a lockbox is via any known security method, including a Secure Sockets Layer (SSL) with 128 bit or higher encryption. An authorized user only can modify the lockbox security protocol and process transactions via the interface. A permanent record of security protocol modifications is maintained thus providing guarantees of the integrity of any transaction. In one embodiment, the lockbox location is identified with a URL (uniform resource locator) that identifies an IP address for a specific computer connected to the internet and the location of the lockbox on the computer. In other embodiments, the lockbox contents can be stored at multiple locations. The functionality of the lockbox can also be implemented in other ways as is known to those skilled in the art.

In some embodiments, the lockbox can be bundled with other electronic accounts and services stored on the internet. For example, the lockbox functionality can be accessed through a MyYahoo! account at www.yahoo.com, Yahoo! messenger account, Microsoft messenger account, Microsoft Passport account, or through a Microsoft Hotmail account. In some embodiments, the contents of the lockbox can only be accessed by the owner of the lockbox, even though the lockbox electronic files may be stored on someone else's server.

In some embodiments, some private information is available only if a certain access conditions are met. For example, a lockbox can be opened with a password but a bank account may not be available if the lockbox is not accessed via a biometric or other combination of access levels In other embodiments the authorization level of the bank account can be limited to a predetermined amount (e.g., $10,000) unless a biometric is used to access the lockbox. Generally, the level of access to the lockbox can vary depending on the access mechanism used to open the lockbox.

The access protocol can also perform actions based on the protocol used to access the account. For example, in order to prevent successfully accessing the lockbox under threat of force, the access protocol can issue and alert to law enforcement authorities if a protocol is followed or not followed. For example, authorized access is permitted under a first access code and biometric. Access is permitted, and law officials are notified, under a second access code and biometric. Other known security protocol can be implemented to maintain the security of the lockbox.

Once a lockbox is accessed, the user can initiate transactions from within the lockbox environment without providing any private information to others, including a service provider or other third party. The service provider 308 or transaction site 314 receives enough information to process the transaction. Typically, private information is unnecessary to process a transaction. If private information is provided, it is with the express permission of the lockbox owner. Transactions are events that require authorization from a user. The lockbox can maintain a log of transactions to provide audit functionality. The audit functionality can identify the who, what, when, and where for each transaction. Transactions are typically financial transactions or identity events. Transactions can include the purchase of products or services, physical identification, and electronic identification. The purchase of products or services can be electronically via any communications method. This can include remote methods such as the internet, phone, or wireless connections or any an in person face-to-face transaction. Physical identification transactions are typically associated with authorizing access to facilities or to grant permissions. For example, an identification transaction can be to access a building, pass a security checkpoint, exercise driving privileges, or receive other privileges or authorizations. Electronic identification is typically related to documents transfers, email, audio conferencing, or videoconferencing.

Transactions can be events that are initiated by an authorized user via a lockbox 302 or by a service provider 308 or transaction site 314. For example, financial accounts within the lockbox can receive payments from a third party. The payment can be directed to the lockbox and it can be distributed to accounts managed by the lockbox according to protocol established by the lockbox user. Transactions can also be inter-lockbox transactions in that the other party to the transaction is processing the transaction through another lockbox. For example, a first individual seeking to enter into a secure agreement can initiate a digital signature and payment from the first individual's lockbox for receipt by a second individual's lockbox upon the second individual confirming his or her identify via his or her lockbox. The second individual can return the agreement via the same protocol. The first individual can verify the sender of the agreement and also track any manipulation or changes to the document.

Transactions are initiated by the user and result in the user providing only enough information outside the lockbox to enable the transaction to be completed. For example, in a financial transaction involving an on-line purchase of an item with a credit card, the necessary information for the online merchant to process the transaction is 1) receipt of payment and 2) receipt of the shipping address so the merchant can have the item delivered to a purchaser. In this example, the lockbox can initiate a transaction that causes a payment to be made from the user's credit card account to the merchant's account. Since the transaction is initiated within the lockbox, the merchant does not receive any private information belonging to the user as is common with non-lockbox online transactions.

For an identity transaction, the information provided by the lockbox is only enough to enable the transaction to be completed. For example, to access a secure facility, the lockbox can initiate the transaction by providing the secure facility with information identifying the authorization level of the individual. Thus, according to the secure facility protocol, once an individual is identified as having a certain level of security access, they can be permitted to access the facility consistent with the authorization.

In one embodiment, the transaction interface within the lockbox can provide links to “favorite” transactions. For example, links can be provided to payments, identification, access keys, and document sharing. The user can customize the layout of the lockbox.

In some embodiments, multiple users can access a lockbox. However, the individual creating the lockbox grants permission to these users to access the lockbox and creates the protocols that govern access to the lockbox. Each user will have a specified security protocol and an associated audit trail to verify what security protocol was followed for a given transaction. For example, a user may grant another access to view certain private information within a lockbox but not to make any modifications. In other embodiments, a user can be granted time-restricted access to a lockbox.

In one embodiment, the lockbox includes an identification module to indicate that a transaction was initiated by an authorized user of the lockbox. The identification module provides an audit trail to verify that an authorized user initiated the transaction and it can also indicates the protocol that was used to access the lockbox. The purpose of the identification module is to indicate to a party to the transaction that the transaction was not fraudulent and thus prevent subsequent revocation of an associated event. Since a lockbox cannot be opened unless authorized by the owner, if the party knows that it was a lockbox transaction it also knows that the transaction was not fraudulent. In one embodiment, the lockbox identification module indicates that the transaction originated with a lockbox. In other embodiments, the lockbox identification module can indicate additional information, including the type of security accessed to initiate the transaction, a third party's rating indicating the reliability of the lockbox security, or other information that enables a party to a lockbox transaction to differentiate potentially fraudulent transactions from non-fraudulent transactions. In yet other embodiments, the identification module does not permit the lockbox user to change the access protocol from a default setting. In other embodiments, the user can change the access protocol and the identification module records that the protocol was changed and can indicate that a transaction was not initiated by a secure lockbox and therefore was potentially fraudulent and/or subject to revocation.

Service providers 308, 310, and 312 are entities that are involved in processing a lockbox transaction. For a merchant transaction, service provider 308 can be a bank that has holds a Visa account belonging to the lockbox owner. In response to an authorization initiated by the lockbox, the service provider 308 can make a payment from the account of the lockbox owner to the account of the merchant. For an identification transaction, the service provider 308 can be an entity that provides a verification that an identification provided by a lockbox is not fraudulent. For example, a lockbox owner seeking to gain entrance to off-site facilities on behalf of his employer may provide identification to his employer (service provider 308) via lockbox 302. The employer service provider 308 would then provide a confirmation or authorization to the transaction site 314 indicating that the employee is in fact an employee that has a given level of access rights.

Transaction sites 314, 316, and 318 are virtual or physical locations where a transaction occurs. Transaction sites 314 can be a merchant physical site, an online merchant site, a physical access point, an email or other electronic document sharing system, or account and other electronic systems associated with a transaction. The transaction site 314 receives information from the lockbox 302 or service provider 308 that is necessary to process the transaction. The transaction site 314 can also receive information identifying that the transaction was initiated by a lockbox.

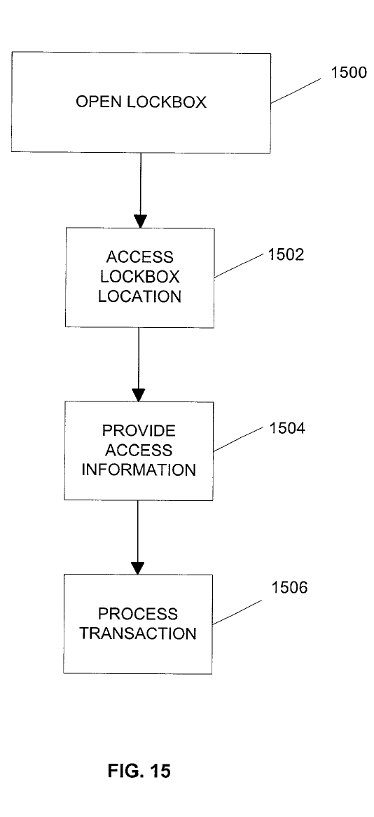

FIG. 15 illustrates a process flow for opening lockbox 302 according to one embodiment of the present invention. Process 1500 represents the start of the open lockbox process. Process 1502 represents the user accessing the lockbox 302 location. In some embodiments, the location of the lockbox 302 can be specified by providing the URL associated with the location of the lockbox on the internet. As is known to those skilled in the art, other protocols can be used to specify the location of electronic files. Process 1504 represents the user providing access information to open the lockbox 302. The access information can include one or more of a password, PIN, biometric, or other known method of providing restricted access. The access mechanism enables the user that placed information in the lockbox to control the protocol associated with removing information from the lockbox. Process 1506 represents the lockbox 302 processing a transaction selected by the user.

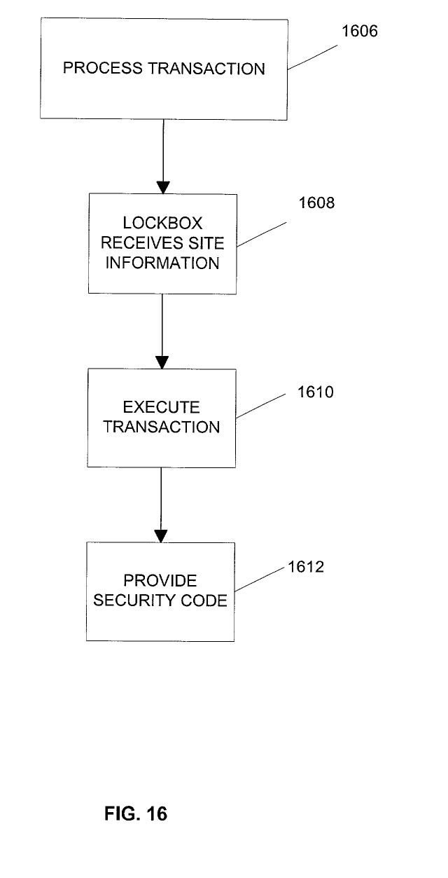

FIG. 16 illustrates a process flow for processing a transaction within lockbox 302 according to one embodiment of the present invention. Process 1608 represents the lockbox 302 receiving site information identifying the transaction site 314. In other embodiments, the lockbox 302 can receive site information identifying the service provider 308. Process 1610 represents the lockbox 302 executing a transaction. Process 1612 represents the lockbox 302 providing a security code to the transaction site 314 or the service provider 308.

The site information identifies the recipient or recipients of a communication from the lockbox to process a transaction. For example, in a merchant transaction, the site information can identify the merchant account that is to receive a payment. For an online transaction the site information can be provided via a link. For a physical merchant transaction the site information can be specified by a user via a computer terminal at the merchant location. In other embodiments the user can specify the site information via a PDA, cell phone, or other remote device. In yet other embodiments, the merchant location can transmit to a user's cell phone, PDA, or other receiving device information identifying the merchant site. The user can use the remote device to open the lockbox 302 and also transmit information identifying the merchant 302 to the lockbox to initiate the transaction.

In other embodiments, the merchant site continuously transmits merchant information readable by the user's cell phone, PDA, or other receiving device. In one embodiment, the bundled encrypted information is transmitted from the merchant site to a user's receiving device where the merchant information is de-bundled and de-encrypted. In another embodiment, the merchant information is one directional, similar to a LORAN system. In other embodiments, the user has transceiver for communicating with the merchant site. The merchant information can include advertising, incentives, pricing, directions to find items in the store,and other information. The information transmitted may be in response to the user's physical location within the merchant site or in response to user input on the receiving device. In some embodiments, the user can select items to purchase based on the merchant information. In one embodiment, payment for the items selected for purchase is via the lockbox. In yet another aspect, the items can be selected and paid for via the receiving device. The items can then be picked up when the user exits the merchant site. In other embodiments, the merchant information can identify the location of the physical security device on the merchant premises that is to receive an authorization for an individual to initiate a lockbox transaction.

The security code provides a signal to differentiate transactions initiated by a lockbox and transactions not initiated by a lockbox. The security code can also identify the level of security (high, low) the type of security (biometric, password) or other information sufficient for the transaction site to differentiate potentially fraudulent transaction from non-fraudulent transactions. In some embodiments, the security code does not identify the lockbox owner or provide any private information from within the lockbox. For example, in a merchant transaction the merchant can receive a payment from Visa associated with a transaction and a shipping address associated with a transaction. The merchant can also receive a security code indicating that the transaction was initiated by a lockbox. Alternatively, the merchant can receive confirmation from a service provider 308 that a transaction was initiated by a lockbox. The merchant may desire to know whether a transaction initiated from a lockbox in order to differentiate transactions that can be repudiated from transactions that necessarily were initiated by an authorized person.

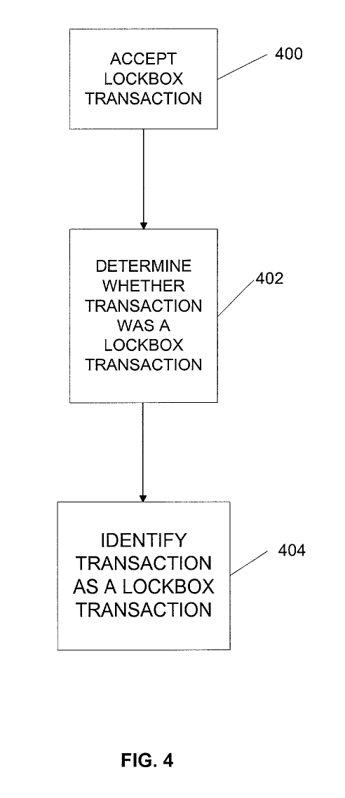

FIG. 4 illustrates a process flow for processing a secure transaction according to one embodiment of the present invention. Process 400 represents a transaction site 314 accepting a lockbox transaction. Process 402 represents determining whether the transaction was a lockbox transaction. Process 404 represents the transaction site 314 or service provider 308 identifying the transaction as a lockbox transaction.

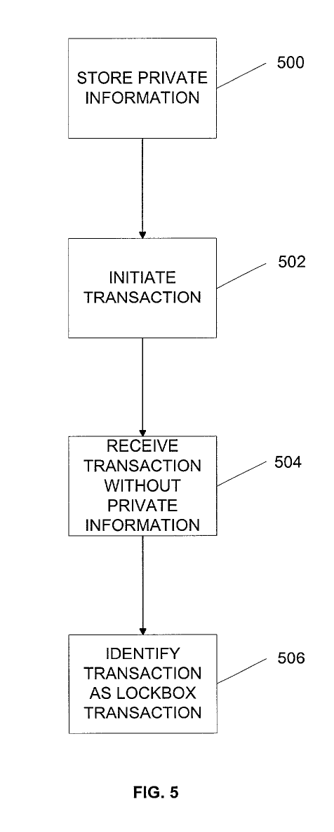

FIG. 5 illustrates a process flow for processing a secure transaction according to another embodiment of the present invention. Process 500 represents the lockbox 302 storing private information. Process 502 represents a user initiating a transaction from within the lockbox 302. Process 504 represents the transaction site 314 receiving the transaction without receiving private information of the user. Process 506 represents the transaction site 314 identifying the transaction as a lockbox transaction.

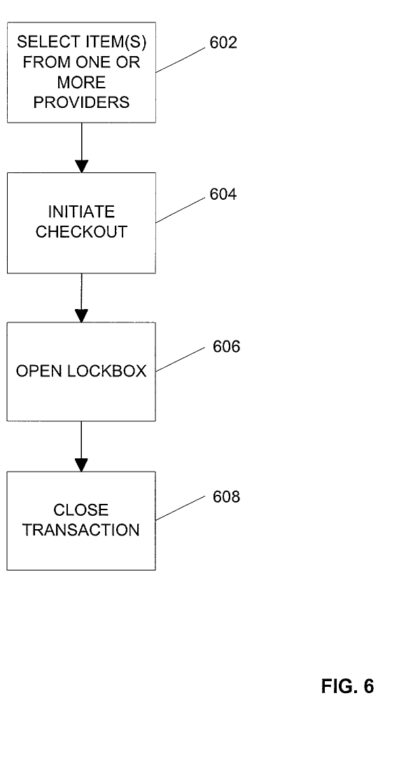

FIG. 6 illustrates a process flow for a merchant application according to one embodiment of the present invention. Process 602 represents a provider computer 103 receiving a selection for one or more items from a user. The items can be products or services. The providers can be providers of products or services to a receiver of products or services. The user is typically a consumer. In other embodiments, the user can be another merchant or supplier of goods or services. Process 604 represents a provider computer initiating a checkout process. Process 606 represents the user opening a lockbox 302. Process 608 represents the provider computer 608 closing the transaction.

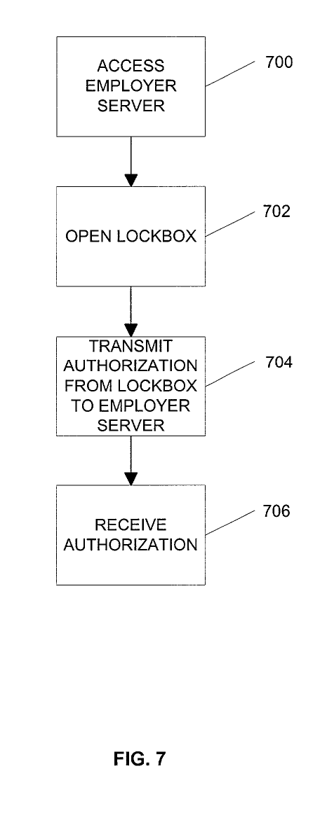

FIG. 7 illustrates a process flow for an off-site identification transaction according to one embodiment of the present invention. In this embodiment, the lockbox user is an employee. Process 700 represents the user accessing the employer server 308 from an off-site location 314. Process 702 represents the user opening his or her lockbox 302. Process 704 represents the lockbox 302 transmitting an authorization to the employer server 308. Process 706 represents the off-site location 314 receiving an authorization from the employer server 308.

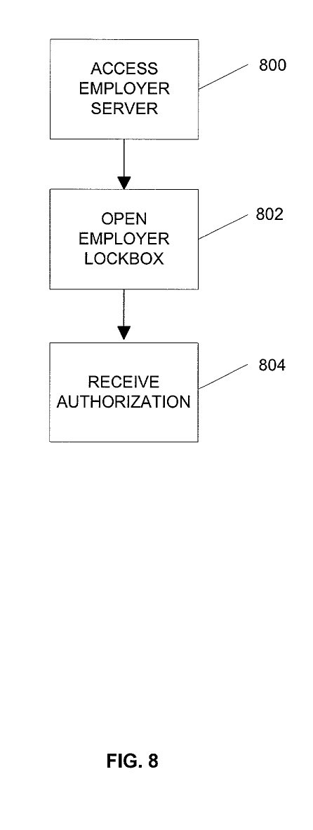

FIG. 8 illustrates a process flow for an off-site identification transaction according another embodiment of the present invention. In this embodiment, the lockbox user is an employee. Process 800 represents the user accessing the employer server 308 from an off-site location 314. Process 802 represents the user opening lockbox 302 which is accessed via the employer server 308. In this embodiment, the lockbox 302 will typically be stored at the location of the employer server and will contain protocol defined by the employer. Process 804 represents the lockbox 302 transmitting an authorization from the employer server 308 to the off-site location 314.

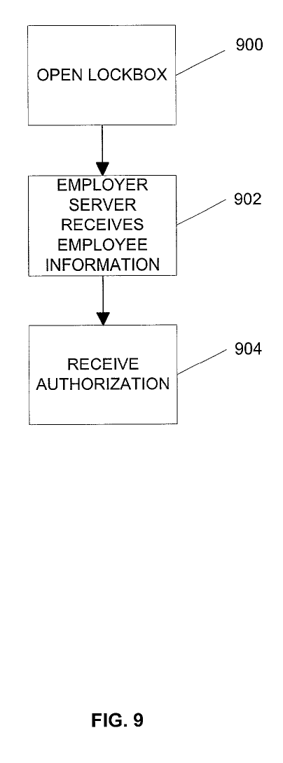

FIG. 9 illustrates a process flow for an off-site identification transaction according another embodiment of the present invention. In this embodiment, the lockbox user is an employee. Process 900 represents the user opening lockbox 302 via an off-site location 314. Process 902 represents the employer server 308 receiving employee information via the lockbox 302. The employee information can include the identity of the employee or information relating to the employee's visit at the off-site location 314. Process 904 represents the lockbox 302 transmitting an authorization from the lockbox 308 to the off-site location 314.

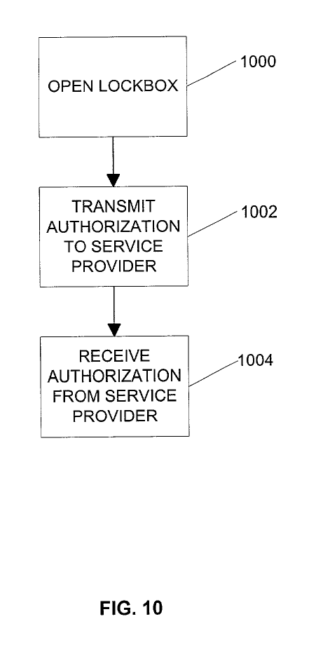

FIG. 10 illustrates a process flow for an identification transaction according to one embodiment of the present invention. Process 1000 represents the user opening lockbox 302. Process 1002 represents the lockbox 302 transmitting an authorization from the lockbox to a service provider 308. Process 1004 represents an identification transaction 314 receiving an authorization from the service provider 308. In one embodiment, the service provider can be an agency issuing an accepted method of identification such as a driver's license. In that embodiment, the driver's license agency provides confirmation of the identity of the user to the identification transaction 314. The authorization can be provided from the lockbox to a service provider 308 via a legacy communication system. For example, a user at a rental car company renting a vehicle can access lockbox 302 to provide a driver's license number to a motor vehicle licensing agency, which then provides an authorization to the rental car company. The communications between the lockbox, motor vehicle licensing agency, and the rental car company can be via legacy communication systems.

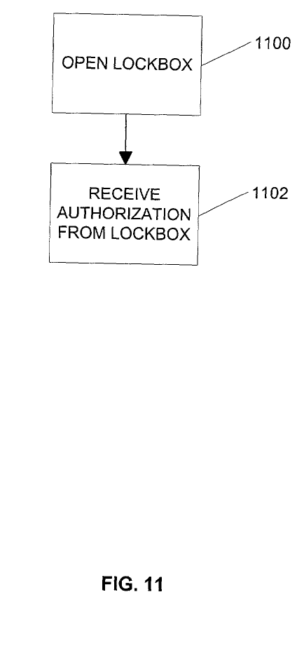

FIG. 11 illustrates a process flow for an identification transaction according to another embodiment of the present invention. Process 1100 represents the user opening lockbox 302. Process 1002 represents an identification transaction 314 receiving an authorization from the lockbox 302. In one embodiment, if the method of identification is a driver's license, the driver's license information is stored in the lockbox 302 and the identification transaction 314 can perform the authorization of the driver's license.

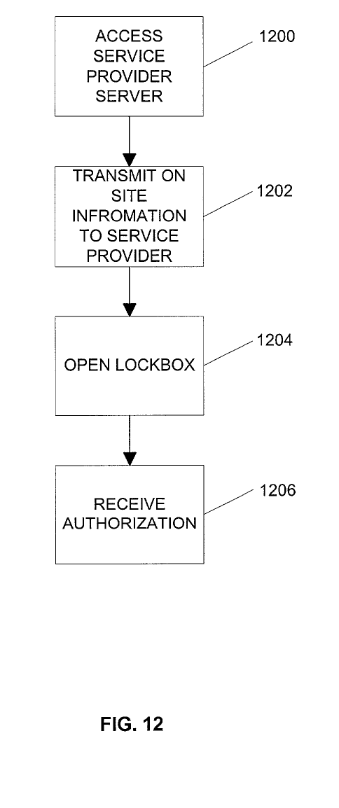

FIG. 12 illustrates a process flow for an identification transaction according to another embodiment of the present invention. Process 1200 represents the user or someone processing the identification transaction accessing a service provider 308. Process 1202 represents the transaction site 314 transmitting identification information for the site to the service provider 308. Process 1204 represents the user opening the lockbox 302. Process 1206 represents the transaction site 314 receiving authorization for the user from the service provider 308.

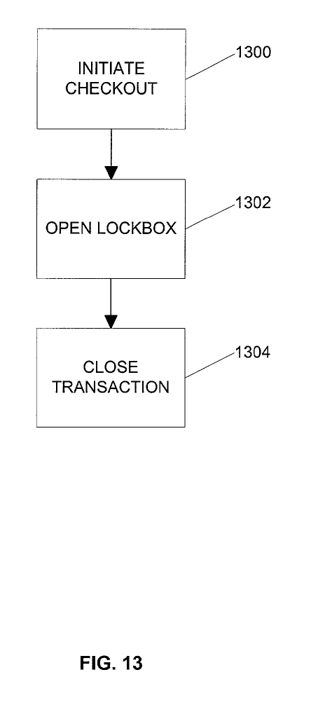

FIG. 13 illustrates a process flow for a merchant transaction according to another embodiment of the present invention. Process 1200 represents the consumer initiating a checkout at the point of sale. Process 1302 represents the consumer opening the lockbox 302. Process 1304 represents the user closing the transaction. Typically, the transaction is closed via payment to the merchant initiated by the consumer via the lockbox 302 using a legacy payment system.

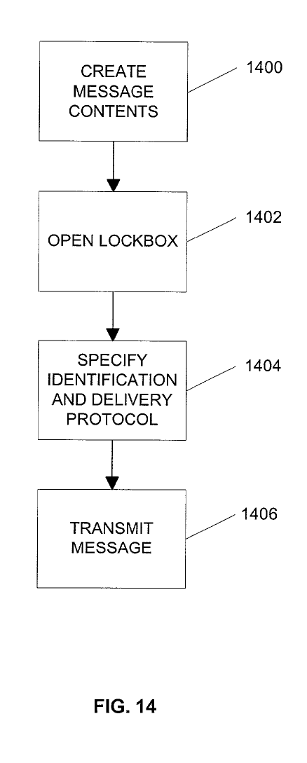

FIG. 14 illustrates a process flow for an electronic document transaction according to one embodiment of the present invention. Process 1400 represents the consumer electronically creating the message. Process 1402 represents the user opening lockbox 302. Process 1404 represents the user specifying the identification protocol and the delivery protocol. Process 1406 represents the user transmitting the message.

Identification protocol is the method by which the user identifies the sender of the message. In one embodiment, the identification protocol can include one or more of the source of the message (lockbox or non-lockbox), the identity of the sender (name, anonymous, biometric, or other identifier), and the security level used to create the message (lockbox opened by biometric). In other embodiments, the user receives a message and the identification protocol for reading and replying to the message is specified by the received message.

Delivery protocol specifies the identity of the intended recipient, the identification protocol for the recipient to receive the message, the delivery conditions, and monitoring protocol. The delivery conditions specify, for example, whether changes to the message are permitted and if they are permitted whether the creator the document is to be notified of the changes. The delivery conditions can also include the time frame that the message is to be delivered and/or read and whether the document is for the recipient(s)' eyes only or can be forwarded or shared, and under what predefined conditions the document can be read, forwarded, and/or shared. The monitoring protocol specifies the audit trail associated with the message. Other delivery conditions as is known in the art can be specified.

Thus, the present invention is presently embodied as a method, apparatus, computer program product, or computer readable media encoding a computer program for processing secure transactions.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. In an interactive communications network, a method of processing a transaction via a lockbox storing private information that is accessible via a security protocol, comprising:
accepting a transaction initiated by a lockbox;
determining whether the transaction was initiated by a lockbox; and
identifying the transaction as a lockbox transaction.

2. The method of claim 1, wherein the determining step includes the step of determining what security protocol was used to initiate the transaction.

3. The method of claim 2, wherein the security protocol is selected from a group comprising a PIN, biometric, and password.

4. The method of claim 1, further comprising the step of saving a change in security protocol.

5. The method of claim 1, wherein the transaction is a merchant transaction, wherein merchant information is transmitted to the lockbox, the merchant information identifying the merchant.

6. The method of claim 5, wherein the merchant transmits merchant information identifying the merchant to a remote device operated by a user.

7. The method of claim 1, wherein the transaction is a payment by a third party.

8. The method of claim 1, wherein the transaction is an identification transaction.

9. The method of claim 1, wherein the transaction is an authorization level.

10. The method of claim 8, wherein the identification transaction is an electronic document transfer.

11. The method of claim 8, wherein the identification transaction is provides access to a secure facility.

12. A system for processing transactions in an interactive communications network, comprising:
a lockbox module storing private information accessible via a security protocol;
a transaction module coupled to the lockbox module for initiating a transaction;
a transaction site module for receiving a transaction, wherein the transaction site module does not receive any private information; and
an identification module for identifying a transaction as originating from a lockbox.

13. The system of claim 12, further comprising an audit module for storing a change in security protocol.

14. The system of claim 13, wherein the audit module stores transaction information, wherein the transaction information includes the security protocol associated with a transaction.

15. The system of claim 12, wherein the identification module determines what security protocol was used to initiate a transaction.

16. The system of claim 15, wherein the security protocol is selected from a group comprising a PIN, biometric, and password.

17. The system of claim 12, wherein the transaction module receives identification information from a transaction site.

18. The method of claim 12, wherein the transaction is a payment by a third party.

19. The method of claim 12, wherein the transaction is an identification transaction.

20. The method of claim 12, wherein the transaction is an authorization level.

21. The method of claim 19, wherein the identification transaction is an electronic document transfer.

22. The method of claim 19, wherein the identification transaction is provides access to a secure facility.

23. An apparatus for processing a transaction via a lockbox storing private information that is accessible via a security protocol in an interactive communications network, comprising:
a computer, operatively connected to the interactive communications network, for accepting a transaction initiated by a lockbox; determining whether the transaction was initiated by a lockbox;
and identifying the transaction as a lockbox transaction.

24. An article of manufacture comprising a program storage medium readable by a computer having a memory, the medium tangibly embodying one or more programs of instructions executable by the computer to perform method steps for processing a transaction via a lockbox storing private information that is accessible via a security protocol, the method steps comprising:
accepting a transaction initiated by a lockbox;
determining whether the transaction was initiated by a lockbox; and
identifying the transaction as a lockbox transaction.
